(19) United States
(12) Patent Application Publication
(10) Pub. No.: US 2011/0055076 A1
(43) Pub. Date: Mar. 3, 2011

(54) RESPONSE TO ALERT MESSAGE

(76) Inventors: Greg Trifiletti, San Francisco, CA (US); Ayman Hammad, Pleasanton, CA (US)

(21) Appl. No.: 12/849,931

(22) Filed: Aug. 4, 2010

Related U.S. Application Data
(60) Provisional application No. 61/236,808, filed on Aug. 25, 2009.

(51) Int. Cl. G06Q 40/00; G06F 15/16

(52) U.S. Cl. 705/39; 709/246

(57) ABSTRACT

One embodiment of the invention is directed to a system comprising a server computer, a database coupled to the server, and a notification device in operative communication with the server. The server comprises a processor and a computer readable medium coupled to the processor. The computer readable medium comprises computer readable program code embodied therein. The computer readable program code is adapted to be executed by the processor to receive a request to modify delivery instructions for alerts associated with a consumer, and modify delivery instructions for alerts associated with the consumer.

### CROSS-REFERENCES TO RELATED APPLICATIONS

The present invention is a non-provisional application and claims priority to U.S. Provisional Application No. 61/236,808, filed on Aug. 25, 2009, the entire contents of which are herein incorporated by reference.

### BACKGROUND

A payment processing network that performs transaction processing, may be used for a variety of information-based services, one of which is notification and alert messages that enhance the user payment experience. Alert messages can be derived from the inherent information in each transaction and other customization settings. Alert messages provide a means of notifying a user about recent transactions and/or account activities in a tailored format. Such alerts may be in the form of messages tailored based on various metrics. These metrics may specify the type of information a user wants to see such as recent transactions, account balance, transaction amounts over specified pre-set limits, and/or format of the alerts which may specify the language, amount of detail and the type of user devices used to receive the messages, among others.

The current systems, however, have a number of limitations. For example, alerts sent via SMS may have a message length limitation that causes information in the alerts to be truncated. There is no easy way for a user to request more information. Further, there is no easy way for a user to change delivery options for alerts.

Embodiments of the invention address these problems and other problems individually and collectively.

### BRIEF SUMMARY

Embodiments of the invention are directed to systems and methods for providing and responding to alerts related to payment transactions.

One embodiment of the invention is directed to a system comprising a server computer, a database coupled to the server, and a notification device in operative communication with the server. The server comprises a processor and a computer readable medium coupled to the processor. The computer readable medium comprises computer readable program code embodied therein. The computer readable program code is adapted to be executed by the processor to receive a request to modify delivery instructions for alerts associated with a consumer, and modify delivery instructions for alerts associated with the consumer.

Another embodiment of the invention is directed to a method comprising receiving, at a server computer, a request to modify delivery instructions for alerts associated with a consumer, and modifying delivery instructions for alerts associated with the consumer.

Another embodiment of the invention is directed to a method comprising receiving, at a server computer, a request for more information related to an alert associated with a payment transaction wherein the alert was received by a consumer at a notification device, determining if the request is proper, if the request is proper, obtaining the more information requested, and sending a response message with the more information.

Another embodiment of the invention is directed to a notification device comprising a processor, an antenna coupled to the processor, and a computer readable medium coupled to the processor. The computer readable medium comprising code for receiving alerts associated with a consumer account, code for sending a request to modify delivery instructions for the alerts wherein a server computer associated with a payment processing network receives a request to modify delivery instructions for alerts associated with a consumer, modifies delivery instructions for alerts associated with the consumer, and provides confirmation that delivery instructions for alerts associated with the consumer have been modified as requested.

Other embodiments of the invention are directed to computer readable media comprising code for performing the above-described methods as well as systems, apparatuses and devices that perform the methods and/or that use the computer readable media.

These and other embodiments are described in further detail below.

### BRIEF DESCRIPTION OF THE DRAWINGS

FIG. 1 shows a system, according to an embodiment of the invention.

FIG. 2 shows the architecture of a subset of the system shown in FIG. 1, according to an embodiment of the invention.

FIG. 3 shows a block diagram of an exemplary computer apparatus.

FIG. 4 illustrates an enrollment process, according to an embodiment of the invention.

FIG. 5 shows a flowchart illustrating steps in a method according to an embodiment of the invention.

FIG. 6 shows a flowchart illustrating steps in a method according to an embodiment of the invention.

FIG. 7-9 show the display on an exemplary mobile device according to embodiments of the invention.

### DETAILED DESCRIPTION

Embodiments of the invention are directed to systems, apparatuses and methods that allow a user (e.g., a cardholder) to enroll for, receive and respond to (e.g., request a change in delivery instructions, request more information, etc.) alerts sent via a notification device (e.g., mobile phone).

For example, a user may desire to change delivery instructions for his alerts. The user may text “pause” to any previous text alert or to a payment processing network short code to pause all alerts associated with a notification device number. If the user receives alerts for more than one account and just wants to pause alerts for one account, he may include an account identifier when he texts “pause” to specify that he only wants alerts paused for the account associated with the account identifier. The pause text message is then sent to an IP Gateway via mobile device carriers and the IP Gateway pauses the alerts and sends a confirmation to the user that the alerts have been paused. When the user wants to receive alerts again, he can text “resume” to start receiving alerts.

An alert message may communicate required details in a single communication or provide a method for the user to request additional information using the same communication channel. For example, a transaction alert received via SMS for an internet purchase may not include a merchant name due to a message length limitation. The consumer can send an SMS message to request the merchant name for this transaction. For example, the user can text “more” to the IP Gateway. The IP Gateway will generate an alert message to send to the user 110 that contains more information for the transaction. Some other examples of requests for more information include, requesting information for the last three transactions the user had made on that account (or on any account), requesting to talk to a customer representative, requesting information on whether the portable consumer device (e.g., credit card) used for the transaction was swiped or keyed in for the purchase, and requesting the total amount of money spent at a particular merchant in the last 30 days.

Additional details regarding embodiments of the invention are described below.

System

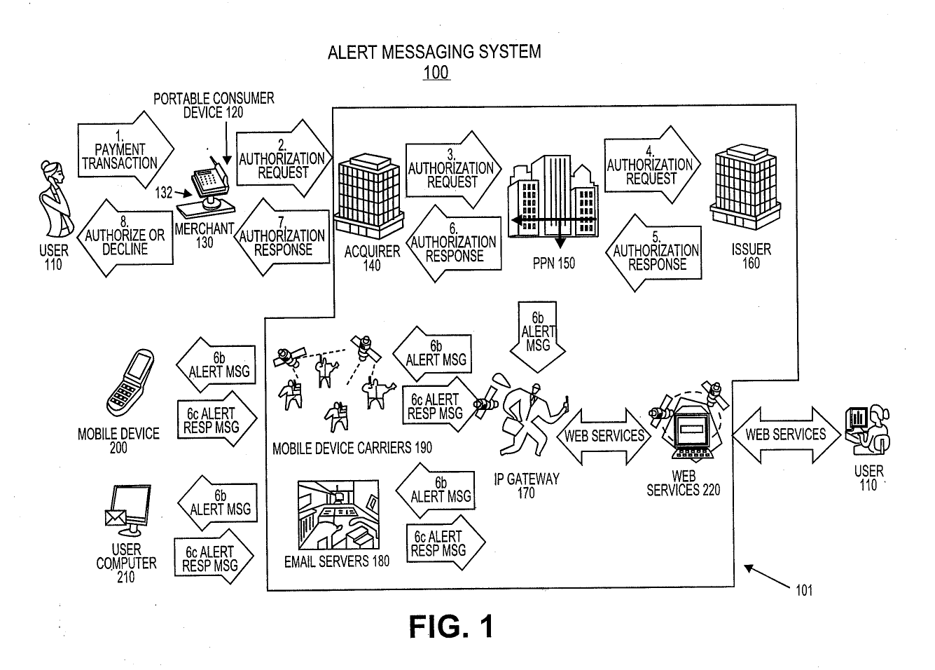

FIG. 1 illustrates a system 100 in accordance with an embodiment of the invention. The system 100 includes a user 110, a portable consumer device 120, a merchant 130, an access device 132, an acquirer 140, a Payment Processing Network (PPN) 150, an issuer 160, an IP Gateway 170, mobile device carriers 190, email servers 180, a mobile device 200, a user computer 210, and web services 220, operatively coupled together. Although one user 110, one mobile device 200, one user computer 210, one merchant 130, one acquirer 140, and one issuer 160 are shown, there may be any suitable number of any of these entities in intelligent alert messaging system 100.

User 110 refers to an individual or organization such as a business that is capable of purchasing goods or services or making any suitable payment transaction with merchant 130. User 110 may also be referred to as a consumer or cardholder throughout this description. User 110 is in operative communication with the portable consumer device 120. Merchant 130 has an access device 132 for interacting with the consumer portable device 120 and acquirer 140 associated with merchant 130. Acquirer 140 is in communication with issuer 160 through payment processing network 150.

Portable consumer device 120 refers to any suitable device that allows the payment transaction to be conducted with merchant 130. Portable consumer device 120 may be in any suitable form. For example, suitable portable consumer devices 120 can be hand-held and compact so that they can fit into a consumer's wallet and/or pocket (e.g., pocket-sized). They may include smart cards, magnetic stripe cards, keychain devices (such as the Speedpass™ commercially available from Exxon-Mobil Corp.), etc. Other examples of portable consumer devices 120 include cellular phones, personal digital assistants (PDAs), pagers, payment cards, security cards, access cards, smart media, transponders, and the like. In some cases, portable consumer device 120 may be associated with an account of user 110 such as a bank account.

Merchant 130 refers to any suitable entity or entities that make a payment transaction with user 110. Merchant 130 may use any suitable method to make the payment transaction. For example, merchant 130 may use an e-commerce business to allow the payment transaction to be conducted by merchant 130 and user 110 through the Internet. Other examples of merchant 130 include a department store, a gas station, a drug store, a grocery store, or other suitable business.

Access device 132 may be any suitable device for communicating with merchant 130 and for interacting with portable consumer device 120. Access device 132 can be in any suitable location such as at the same location as merchant 130. Access device 132 may be in any suitable form. Some examples of access devices 132 include POS devices, cellular phones, PDAs, personal computers (PCs), tablet PCs, hand-held specialized readers, set-top boxes, electronic cash registers (ECRB), automated teller machines (ATMs), virtual cash registers (VCRs), kiosks, security systems, access systems, websites, and the like. Access device 132 may use any suitable contact or contactless mode of operation to send or receive data from portable consumer devices 120.

If access device 132 is a POS terminal, any suitable POS terminal may be used and may include a reader, a processor, and a computer-readable medium. Reader may include any suitable contact or contactless mode of operation. For example, exemplary card readers can include radio frequency (RF) antennas, optical scanners, bar code readers, magnetic stripe readers, etc. to interact with portable consumer device 120.

Acquirer 140 refers to any suitable entity that has an account with merchant 130. In some embodiments, issuer 160 may also be acquirer 140.

Payment processing network (PPN) 150 refers to a network of suitable entities that have information related to an account associated with portable consumer device 120. This information includes data associated with the account on portable consumer device 120 such as profile information, data, and other suitable information.

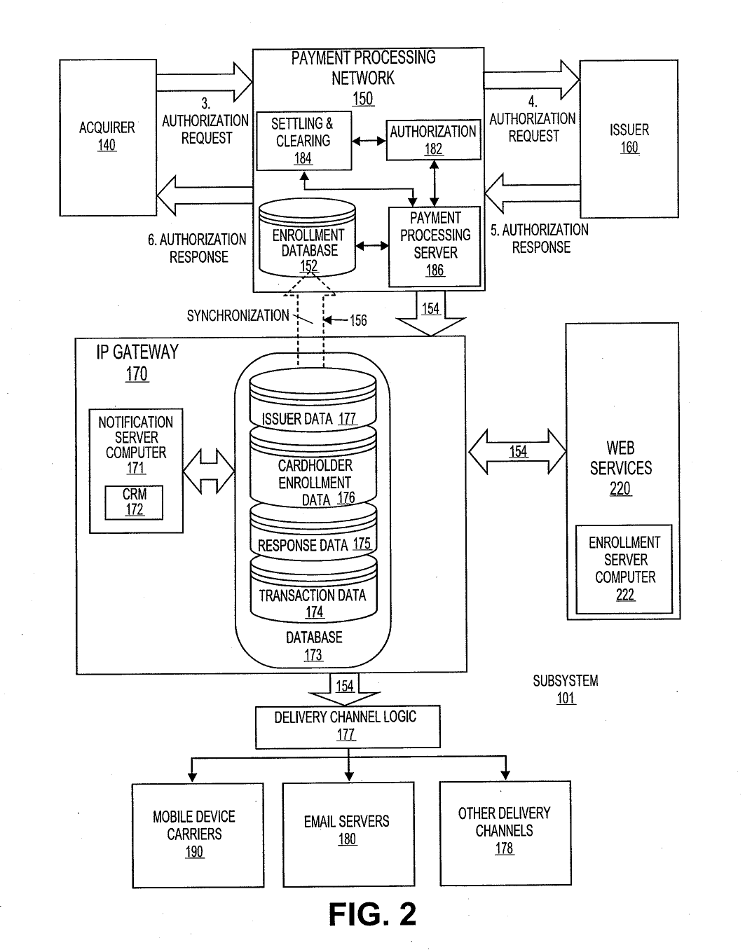

Payment processing network 150 may have or operate a server computer and may include a database. The database may include any hardware, software, firmware, or combination of the preceding for storing and facilitating retrieval of information. Also, the database may use any of a variety of data structures, arrangements, and compilations to store and facilitate retrieval of information. The server computer may be coupled to the database and may include any hardware, software, other logic, or combination of the preceding for servicing the requests from one or more client computers. Server computer may comprises one or more computational apparatuses and may use any of a variety of computing structures, arrangements, and compilations for servicing the requests from one or more client computers. For illustration purposes, examples of some of the elements of the payment processing network 150 such as authorization module 182, settling and clearing module 184 and payment processing server computer 186 are shown in FIG. 2. Each of settling and clearing module 184, authorization module 182, and the payment processing server 186 contain an appropriate number of computer readable mediums and processors (not shown) that perform the functions described herein with respect to these elements.

Payment processing network 150 may include data processing subsystems, networks, and operations used to support and deliver authorization services, exception file services, and clearing and settlement services. An exemplary payment processing network 150 may include VisaNet™. Networks that include VisaNet™ are able to process credit card transactions, debit card transactions, and other types of commercial transactions. VisaNet™, in particular, includes a integrated payments system (Integrated Payments system) which processes authorization requests and a Base II system which performs clearing and settlement services. Payment processing network 150 may use any suitable wired or wireless network, including the Internet.

Issuer 160 refers to any suitable entity that may open and maintain an account associated with portable consumer device 120 for user 110. Some examples of issuers may be a bank, a business entity such as a retail store, or a governmental entity. In many cases, issuer 160 may also issue portable consumer device 120 associated with the account to user 110.

The system 100 also includes a mobile device 200 in operative communication with user 110 for displaying alert messages to the user 110. Mobile device 200 may be in any suitable form. For example, suitable mobile device 200 can be hand-held and compact so that they can fit into a consumer's wallet and/or pocket (e.g., pocket-sized). Some examples of mobile device 200 include desktop or laptop computers, cellular phones, personal digital assistants (PDAs), pagers, payment cards, security cards, access cards, smart media, transponders, and the like. In some embodiments, mobile device 200 and portable consumer device 120 are embodied in the same device. Mobile device 200 is a type of notification device.

User computer 210 may be a personal computer or a laptop. The user computer 210 may run an operating system such as Microsoft Windows™ and may have a suitable browser such as Internet Explorer™. User computer 210 is a type of notification device.

Mobile device carriers 190 refer to entities that provide wireless infrastructures for wireless data transfer and communication via cellular phone or other mobile devices. Example of such entities are AT&T™, Verizon Wireless™, T-Mobile™, etc.

Email servers 180 are server computers configured to receive an email from a network connection and store the email in memory for future retrieval.

IP (Internet Protocol) Gateway 170 refers to an entity that generates and delivers notifications and alert messages to various delivery channels and may also receive alert messages from various delivery channels. IP Gateway may include one or more servers and databases for generation of the alert messages, receiving alert messages and retrieval of data. IP Gateway 170 may be part of the payment processing network 150 or may be a separate entity in communication with payment processing network 150. The IP Gateway can also include computer readable media and processors for executing reporting and billing logic (such as reporting on billings, status, fraud, consumer data, etc.). The IP Gateway can have a messaging interface for delivery channel logic. This messaging interface allows the IP Gateway to send and receive messages using any suitable communication channel, such as Text (SMS) messages, email, web delivery, etc. The IP Gateway further provides web services, for access to the system using one or more web enabled browsers.

IP Gateway 170 is in communication with payment processing network 150. IP Gateway 170 receives the transaction data from the payment processing network 150 and generates alert messages 6b. IP Gateway 170 is also in communication with the mobile device carriers 190, email servers 180, and web services 220. The mobile device carriers 190 are in operative communication with the mobile device 200, and the email servers 180 are in operative communication with the user computer 210. The alert messages 6b that are generated from IP Gateway 170 are sent to the mobile device carriers 190 and/or mail servers 180 to be sent to the mobile device 200, and/or to be accessed by the user computer 210. The IP Gateway 170 receives and processes alert response messages 6c. User 110 may send alert response messages 6c via a mobile device 200 or user computer 210. The alert messages 6c are sent to the mobile device carriers 190 and/or email server 180 to be sent to the IP Gateway 170. The web services 220 is also in operative communication with the user 110 for enrolling the user 110 in the alert messaging service provided by the system 100. The IP Gateway is described in further detail below in reference to FIG. 2.

Web services 220 may be in the form of one or more server computers and a website which allows users to enroll in the alert messaging service. Web services may include an enrollment server computer 222 (as shown in FIG. 2) that hosts a website which provides an electronic enrollment form to users to enroll in the alert messaging service. Web services 220 may be provided by the issuer 160 or the payment processing network 150. The web services 220 can further provide customer service functions for the user 110 and the issuer 160.

Subsystem

FIG. 2 is a diagram illustrating the architecture of a subsystem 101 of the system 100 and includes more details about the IP Gateway 170. The IP Gateway 170 includes a notification server computer 171 having a computer-readable medium (CRM) 172, and a processor (not shown) that is coupled to the CRM 172. Although one CRM 172 is shown in FIG. 2, the notification server computer 171 may house more than one CRM as needed. The notification server computer 171 is in communication with database 173. In some embodiments, database 173 may be included in the notification server computer 171. Database 173 contains alert customization data that are used to generate the alert messages (e.g., for determining how to handle alerts and transactions using specific parameters). The alert customization data includes transaction data 174, response data 175, cardholder enrollment data 176 (which includes account identifiers associated with portable consumer devices of users enrolled in the alert messaging service), and issuer data 177. Cardholder enrollment data 176 are synchronized with the enrollment database 152 via the synchronization link 156. The enrollment database 152 contains data related to users who are enrolled in the alert messaging service. Response data 175 includes information necessary for responding to alert response messages 6c sent by users 110. This may include various supported commands (e.g., MORE, LAST 3 TRANSACTIONS) and the corresponding instructions for generating alert messages 6b to respond to the commands.

IP Gateway 170 is in communication with payment processing network 150, and web services 220 via the network connection 154 which may be in any suitable form. The network connection 154 may include, for example, at least a portion of the Internet. Delivery channel logic 177 is in communication with IP Gateway 170, mobile service carriers 190, email servers 180, and other delivery channels 178.

In one embodiment, IP Gateway 170 may be part of the payment processing network 150 and only the server(s) and database(es) used to generate the alert messages be operationally separated from the elements of the payment processing network 150 that are used to perform the payment transactions. In other embodiments, IP Gateway 170 may be separated from the payment processing network 150, as shown in FIG. 2, and embodied as a separate entity.

Notification server computer 171 may be a powerful computer or cluster of computers. For example, the server computer can be a large mainframe, a minicomputer cluster, or a group of servers functioning as a unit. In one example, the notification server computer may be a database server coupled to a Web server. Notification server computer 171 includes a computer-readable medium (CRM) 172 and a processor (not shown) coupled to the CRM 172.

Database 173 may be in the form of one or more server computers for storage of data. It may also be in the form of one or more electronic storage units (stand alone hard drives) capable of storing electronic data.

Delivery channel logic 177 may be in the form of an application program that sends the alert messages to the appropriate delivery channel. Delivery channel logic 177 may be part of the IP Gateway 170 or the payment processing network 150. In some embodiments, delivery channel logic runs on a server computer that is in communication with the notification server computer 171. In other embodiments, delivery channel logic may run on the notification server computer 171.

Enrollment

In order to receive alert messages, user 110 may enroll for the service provided by the alert messaging system 100. There may be multiple ways in which the user 110 may become enrolled in the alert service. For example, the user 110 may enroll through a payment processing network 150, an issuer 160, or even through a merchant 130. In some embodiments, the user 110 may be enrolled automatically by the issuer 160 that issues the portable consumer device 120. Enrollment may also be done in a batch mode, by file delivery from issuer 160 or by file delivery from some other party. In other embodiments, the issuer 160 or payment processing network 150 may provide the alert service as an option to the user 110 at which time the user 110 may enroll in the alert messaging service either by contacting a customer service representative over the phone (provided either by the issuer 160 or payment processing network 150), or by accessing a web site and filling out an online application. This may be done by web services 220. The web services 220 can allow for enrollment of users in the services provided by the IP Gateway 170. In certain implementations, the web site may be hosted by one entity but can redirect the consumer to a site hosted by another entity.

In some embodiments, issuer 160 may integrate its website with the web services 220, and communicate with web services 220 on behalf of the user 110. FIG.

4 illustrates embodiments where user 110 is enrolled in the alert service by communicating with a website provided by the issuer 160 that is integrated with web services 220, and by communicating directly with the issuer 160. These embodiments are illustrated as examples of two of many possible ways that users may be enrolled in alert services. These embodiments also illustrate the degree of flexibility and customization that the architecture of FIG. 2 provides for other entities such as issuer 160 to interact with the alert messaging system while maintaining the security, and without using the resources of the payment processing network 150. Therefore, those skilled in the art will understand that the following embodiments are illustrative and not restrictive.

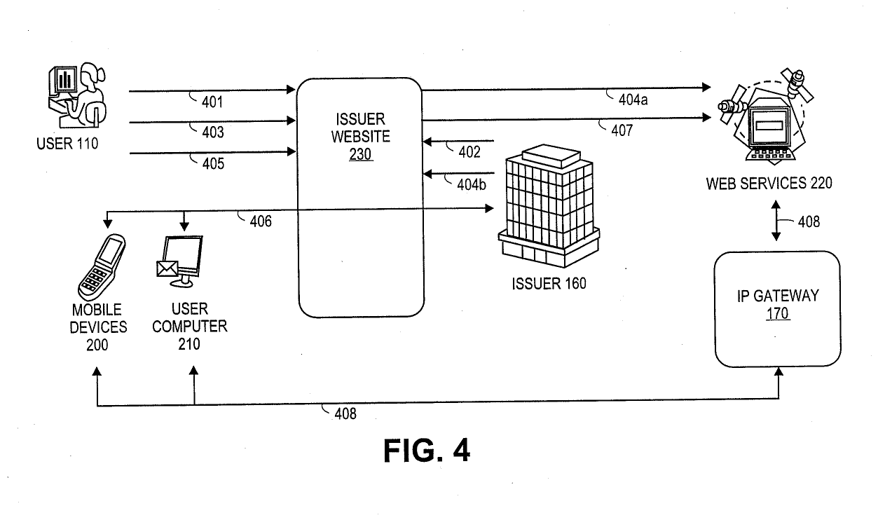

As shown in FIG. 4, user 110 enters the issuer web site 230 and authenticates himself (step 401). Issuer 160 then indicates services eligibility for the accounts that the user 110 holds with the issuer 160 (step 402). User 110 then selects one or more of his accounts for enrollment (step 403). Next, user 110 is presented with an electronic enrollment form to be filled out. Appropriate fields of this form may be provided by the issuer 160, or based on an arrangement between issuer 160 and web services 220, the fields may be provided by the web services 220. For example, a user 110 may provide a user name, user preferences, an account number, an indication of a reward program, contact information, and how he or she would like to receive alerts (e.g., SMS, email, etc.). The contact information can include, among other things, mobile contact information in which the consumer may be contacted through a mobile device. For example, the mobile contact information may include a mobile phone number. The consumer can receive SMS messages and other types of instant mobile messages. In various embodiments, the consumer may access the enrollment system to update consumer information and change how he would like to receive alerts.

Step 404a illustrates an embodiment in which issuer 160 requests and receives appropriate fields for user 110 from web services 220. Step 404b illustrates the embodiment in which the issuer 160 directly presents the appropriate enrollment fields for the user 110. From the vantage point of the user 110 there will be no difference in either of these embodiments, because the integration of the issuer website 230 and the web services 220 is done in the background.

Thereafter, user 110 completes the enrollment information (step 405). Issuer 160 conducts a channel verification and completes the user activation (step 406). In step 406, issuer 160 verifies and activates the delivery channels such as email, SMS messaging, etc. that user 110 requested when filling out the electronic enrollment form.

The user activation status is then passed by issuer 160 to the IP Gateway 170 via web services 220 (step 407). Finally IP Gateway begins processing alerts for the enrolled account(s) of user 110 (step 408).

Once the user 110 is enrolled in the alert service, appropriate information regarding the user 110 such as the preferences and type of user device(es) used for delivery of alerts, account identifier (account number or any other data that identifies the user account enrolled in the alert service), etc. are stored in the cardholder enrollment data 176 in the database 173. Cardholder enrollment data 176 are used along with issuer data 177, transaction data 174, and response data 175 for generation of alert messages. As a result of the enrollment process, cardholder enrollment data 176 in the database 173 will contain a group of account identifiers that indicate the account numbers of users enrolled in the alert messaging service.

In some embodiments, only the transaction requests/responses that are associated with an account that is enrolled in the alert messaging system 100 are sent to the IP Gateway 170. In order for the payment processing network 150 to determine whether the transaction data are associated with a portable consumer device 120 that is enrolled in the alert service, the payment processing network 150 maintains a list of account identifiers (account numbers or any other data that identifies the user accounts enrolled in the alert service) associated with the portable consumer devices of users who are enrolled in the alert messaging service. This list is stored in the enrollment database 152 as shown in FIG. 2. The account identifiers in the enrollment database 152 are synchronized with the appropriate portion(s) of the cardholder enrollment data 175 via synchronization link 156. Synchronization link 156 may be in any suitable form. For example, the synchronization link 156 may be in the form of local area network connection or Internet.

Synchronization link 156 stores a copy of the group of account identifiers that are stored in cardholder enrollment data 176, into enrollment database 152. This will make the enrollment database 152 to act as a “thin” database that stores an appropriate portion of the data in the database 173, and allows the payment processing server computer 186 to initiate the process of alert message generation and delivery by accessing a thin database (enrollment database 152).

Synchronization link 156 performs the synchronization process between an appropriate portion of the data stored in the database 173 and enrollment database 152, at predetermined times or as new data are stored in the database 173. In some embodiments, synchronization link 156 synchronizes the data (the group of account identifiers) at predetermined times per day. For example, in one embodiment, synchronization link 156 may synchronize the data at the end of each day. In this situation, users who enroll their accounts with the alert messaging service will have to wait until the next day for activation. In some other embodiments, synchronization link 156 may synchronize the data as they are stored in the database 173. In such embodiments, user's accounts will be enrolled in the alert messaging service shortly after they finish the enrollment process. In some embodiments, synchronization link 156 may synchronize the data certain number of times per day at predetermined times or based on a predetermined number of new enrolled accounts.

Generating Alerts

In a typical transaction, the user 110 purchases a good or service at the merchant 130 using a portable consumer device 120 such as a credit card, as shown in FIG. 1. The user's portable consumer device 120 may interact with an access device 132 such as a POS (point of sale) terminal at the merchant 130. For example, the user 110 may take a credit card and may swipe it through an appropriate slot in the POS terminal. Alternatively, the POS terminal may be a contactless reader, and the portable consumer device 120 may be a contactless device such as a contactless card or a mobile phone 200 with a contactless element.

An authorization request message is then forwarded to the acquirer 140 (arrow 2 in FIG. 1). The authorization request message is then received by a server computer at the payment processing network 150 (arrow 3 in FIGS. 1 and 2). The payment processing network 150 sends the authorization request message to the issuer 160 (arrow 4 in FIGS. 1 and 2). The issuer 160 then sends an authorization response message to the payment processing network 150 to indicate whether or not the current transaction is authorized (e.g., whether the account has sufficient credit or funds to cover the transaction) (arrow 5 in FIGS. 1 and 2). The payment processing network 150 forwards the authorization response message back to the acquirer 140 (arrow 6 in FIGS. 1 and 2). The acquirer send the response message back to the merchant 130 (arrow 7 in FIG. 1).

After the merchant 130 receives the authorization response message, the access device 132 at the merchant 130 may provide the authorization response message for the user 110 (arrow 8 in FIG. 1). The response message may be displayed by the POS terminal, the portable consumer device 120, or may be printed out on a receipt.

Using the arrangement as shown in FIG. 2, the process of generating alert messages may begin at the time of receiving the authorization request message from acquirer 140 (arrow 3), or at the time of receiving the authorization response message from the issuer 160 (arrow 5), or both, depending on the type of the alert. The authorization request message and the authorization response message include the transaction data. The authorization request messages may contain more data in addition to transaction data. The authorization response messages may also contain more data in addition to transaction data.

After the payment processing network 150 receives an authorization request message from the acquirer 140, authorization response message from the issuer 160, or both, an application program, running on a computer system such as the payment processing server computer 186, compares the account number and/or other forms of account identifier(s) associated with the authorization request message (or the authorization response message) with a list of account identifiers of the enrolled account numbers in the enrollment database 152. If there is a match, which indicates that the account number associated with portable consumer device 120 is enrolled in the alert messaging service, the payment processing network 150 sends the transaction data 174 associated with that particular transaction to the IP Gateway 170.

If the transaction is associated with account number that is not enrolled in the alert service, payment processing network 150 does not send the transaction data to IP Gateway 170 and resumes the payment processing. This prevents the IP Gateway from having to process unnecessary transactions while maintaining a secure and fast process flow. This dual database approach provides for fast processing as it can filter out the transactions that require alert processing from the transactions that do not.

In one embodiment, user 110 may be notified about a transaction before an authorization request message is submitted to the issuer 160. In this situation, transaction data at the time of receiving the authorization request message from the acquirer 140 may be used so that appropriate type of alert is provided to the user 110. This can be used to involve the user 110 in verifying the transaction which may help in fraud detection.

In another embodiment, user 110 may be notified about a transaction after it has been approved or declined by the issuer 160. In this situation, transaction data at the time of receiving the authorization response message from the issuer 160 may be used. This can be used to notify the user about a recent transaction. For example, when user 110 purchases a coffee at a coffee shop, he will receive a message on his mobile device 200 that says: “your card was charged $2.00 at starbucks.”

In some embodiments, when transaction data from issuer 160 are used, an alert may be customized based on the result of the transaction and include additional details that gives an “intelligent” aspect to the alert messages. For example, an alert may be withheld if a transaction is declined to avoid any possible confusion. Alternatively, an alert may be issued stating that the transaction was declined and additional details may be provided to help the user 110 understand why the transaction was declined. For example, an alert in this example may say: “transaction was declined. Insufficient available credit,” or “Transaction was declined. Verification from cardholder is required. Please contact the issuer.”

Utilizing this method and separating the resources and processes, eliminates the burden of processing and generating the alerts from the resources of the payment processing network 150, especially when great level of details and customizations are provided in the alerts. Payment processing network 150 forwards the transaction data, that it normally receives from acquirer 140 and issuer 160, to IP Gateway 170. Further processing and customizing the alert messages is performed by the resources of IP Gateway 170. This may advantageously result in a “real time” or “near real time” process, since when transaction data are received by the IP Gateway 170, generation of the alert messages and the rest of the payment processing are performed in parallel.

In addition to eliminating the processing power needed for generating alerts, separation of processes and resources between payment processing network 150 and IP Gateway 170, may be advantageous for the purpose of delivering the generated alerts which requires additional processing. When alerts are generated by the notification server computer 171, they are sent to the delivery channel logic 177 for delivery to the user 110 via a user device. The delivery channel logic 177 may be in the form of one or more software applications running on one or more computers that are tasked with delivery of the alerts to the appropriate delivery channel(s). In one embodiment, the delivery channel logic may be part of the IP Gateway 170. In another embodiment, the delivery channel logic 177 may be a third party entity that receives the alert message via network connection 154 and sends it to an appropriate user device.

In one embodiment, the alert message may be sent along with an identifier that specifies what form of delivery channel should be used for the delivery of the message. Delivery channel logic 177 is in communication with mobile device carriers 190 and email servers 180, for sending the alert messages in formats that are readable by the mobile device 200, and in the form of email messages that are readable by user computer 210.

In some embodiments, an alert may be sent to a user in the form of Interactive Voice Response (IVR), Instant Message (IM), Voicemail, etc. Therefore, FIG. 2 shows that delivery channel logic 177 is in communication with other delivery channels 178 that can deliver the alert messages in a variety of formats to a user device.

It can be appreciated that the architecture of FIG. 2 provides several advantages. For example, generation of the alerts by the IP Gateway 170 and delivery of the alerts by the delivery channel logic 177, will not overload the resources of payment processing network 150 with additional processing. In addition, this architecture allows for outsourcing of the IP Gateway 170, delivery channel logic 177, or any of their elements while reducing any potential security concerns. Given that IP Gateway 170 receives a copy of the transaction data from payment processing network 150, it can be embodied as a third party entity tasked with generation of the alerts. Same applies to delivery channel logic 177. Moreover, segmenting the resources provides the possibility of shutting down the elements used for alert generation and delivery without impacting the transaction processing operations of the payment processing network 150.

Responding to Alerts

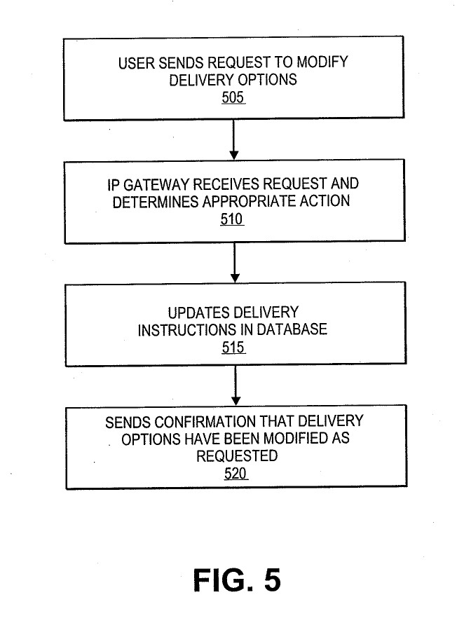

A user may want to change his delivery options for alerts. For example, he may want to pause his alerts for a period of time. The user may be going on vacation abroad and may not have an international mobile phone plan. Thus, he may not want to have a alerts queued up while he is gone or he may not want to actually receive them abroad and incur extra charges for receiving them abroad. Or, the user may have gone over his data limit for the month in his mobile device plan and not want to receive alerts until the next month. In one embodiment, and referring to FIG. 5, a user 110 may text “pause” to any previous text alert or a payment processing network short code (e.g., to determine the destination for the text message). After typing in the word “pause” into his mobile device 200, the user 110 would send the alert response message 6c (step 505). The alert response message 6c would be received by the mobile device carriers 190 and the mobile device carriers 190 would send the alert response message 6c to IP Gateway 170.

Once the IP Gateway 170 receives the alert response message it would determine the appropriate action (step 510). Since the alert response message 6c contained the word “pause” the IP Gateway would update the cardholder enrollment data 176 to indicate that alerts for the user are paused (step 515). For example, the IP Gateway 170 may set a flag in the cardholder enrollment data 176 to indicate a pause. At this point, or at a later time, synchronization process may occur between the cardholder enrollment data 176 and enrollment database 152. Thus, the payment processing network 150 will know that the user 110 has alerts paused. For example, the account identifier for the accounts to be paused may be removed from the enrollment database 152 so that the payment processing network would not see the account number as enrolled in the alert service and would not send the transaction data to IP Gateway 170 to generate an alert.

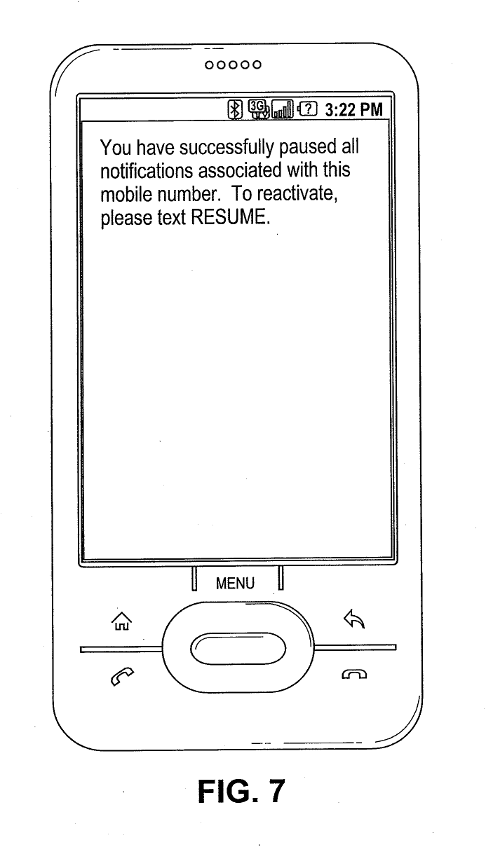

The IP Gateway 170 may then send an alert message 6b to the user 110 to confirm that the alerts have been paused (step 520). For example, the user 110 may receive the alert as shown in FIG. 7.

A user 110 may have several accounts for which he receives alerts. Instead of pausing all alerts for all accounts, the user 110 may only want to pause alerts for one of his accounts. Thus, the user 110 may send an alert response message 6c with “pause” and include an account identifier (e.g., last four digits of the account for which he wants alerts paused) so that the pause will affect only the account for which the account identifier pertains and not all accounts for that user. In this case, an account identifier is typically not the full account number. For security purposes, the account identifier may be the last four digits of the account, or some other identifier for the account. If the account identifier is not included in a “pause” message, the IP Gateway 170 may respond with a message that the account identifier is required to pause alerts for a specific account. The user 110 may include more than one account identifier to pause more than one account. The user 110 may also text “pause all” to clarify that he indeed wants to pause all alerts.

The user 110 may request “pause” on the payment processing network 150 or issuer 160 enrollment site, or have a customer support representative change the account status to “pause.” When pause is enacted for an account, it may affect all delivery channels assigned to that account including text and email. The user 110 may specify if he only wants certain delivery channels to be affected (e.g., only wants to pause text messages).

The user 110 may also specify that the pause last for a specific amount of time. For example, the user 110 may request the pause for a number of minutes (e.g., 20, 45, 60, or 120 minutes), hours, days, weeks, or to end by a specific date. For the example, the user 110 could text “pause for 10 hours” or “pause until Nov. 15, 2010.” If a specific amount of time is specified, the IP Gateway 170 would update the cardholder enrollment data 176 to reflect the amount of time for the pause. For example, the IP Gateway may set a flag that times out at the end of the specified period of time. The IP Gateway 170 may send an alert message 6b to the user 110 to acknowledge the pause and let the user 110 know that the alert service will resume in the amount of time as specified by the user 110. Once the specified amount of time lapses, the IP Gateway 170 would again update the cardholder enrollment data 176 to indicate that the alerts are no longer paused (e.g., remove the flag that indicates the alerts are paused).

At this time, or at a later time, synchronization process may occur between the cardholder enrollment data 176 and enrollment database 152. Thus, the payment processing network 150 will know that the user 110 desires to receive alerts. For example, the account identifier for the accounts to be resumed may be added to the enrollment database 152 so that the payment processing network would see the account number as enrolled in the alert service and would send the transaction data to IP Gateway 170 to generate an alert. The IP Gateway 170 may send an alert message 6b to the user 110 to indicate that alerts are no longer paused.

The user 110 may have the ability to text “resume” to resume alerts. A user 110 may text “resume” to any previous text alert or a payment processing network short code. After typing in the word “resume” into his mobile device 200, the user 110 would send the alert response message 6c (step 505). The alert response message 6c would be received by the mobile device carriers 190 and the mobile device carriers 190 would send the alert response message 6c to IP Gateway 170.

Once the IP Gateway 170 receives the alert response message it would determine the appropriate action (step 510). Since the alert response message 6c contained the word “resume” the IP Gateway would update the cardholder enrollment data 176 to indicate that alerts for the user are resumed (step 515). For example, the flag in the account indicating that the alerts were paused may be removed. At this point, or at a later time, synchronization process may occur between the cardholder enrollment data 176 and enrollment database 152. Thus, the payment processing network 150 will know that the user 110 has alerts resumed. For example, the account identifier for the accounts to be resumed may be added to the enrollment database 152 so that the payment processing network would see the account number as enrolled in the alert service and would send the transaction data to IP Gateway 170 to generate an alert. Alert text messages may not be queued up during the pause, and thus not sent after resume takes place.

The IP Gateway 170 may then send an alert message 6b to the user 110 to confirm that the alerts have been resumed (step 520). For example, the user 110 may receive the alert that says “You have successfully resumed all notifications associated with this mobile number.”

As described above, a user 110 may have several accounts for which he receives alerts and only want to resume alerts for one of his accounts. In this case, the user 110 may send an alert response message 6c with “resume” and include an account identifier (e.g., last four digits of the account for which he wants alerts resumed) so that the resume will affect only the account for which the account identifier pertains and not all accounts for that user. In this case, an account identifier is typically not the full account number. For security purposes, the account identifier may be the last four digits of the account, or some other identifier for the account. If the account identifier is not included in a “resume” message, the IP Gateway 170 may respond with a message that the account identifier is required to resume alerts for a specific account. The resume will only apply to the account associated with the account identifier. If the account identifier is not included in a “resume” message, the IP Gateway 170 may respond with a message that the account identifier is required to resume alerts.

The user 110 may request “resume” on the payment processing network 150 or issuer 160 enrollment site, or have a customer support representative change the account status to “resume.” When resume is enacted for an account, it may affect all delivery channels assigned to that account including text and email. The user 110 may specify if he only wants certain delivery channels to be affected (e.g., only resume email messages).

The user 110 may want to stop receiving alerts altogether. In this case the user can text “stop” to any previous text alert or a payment processing network short code. As described above for “pause” and “resume,” the user's delivery options would be updated to indicate he does not want to receive alerts.

The system can also queue a recurring payment and hold until a pre-set time window. The window may be established at the account level, issuer level, and/or payment processing network level. Within the window, no alerts will be sent to the user 110. A window may be provided by alert type (e.g., cross border enabled and all else disabled during the window). When the window expires, all queued messages will be sent.

The platform may have the ability to suppress messages for recurring payments as identified by a flag in the payment processing network 150 (e.g., in the VIP). Suppression of the recurring payment may be possible at the account level, BIN level, BID level, issuer level, and/or payment processing network level. The system may be able to queue the recurring payment and hold until a pre-set time window as defined at the account level. A replacement variable may be used to indicate recurring payment.

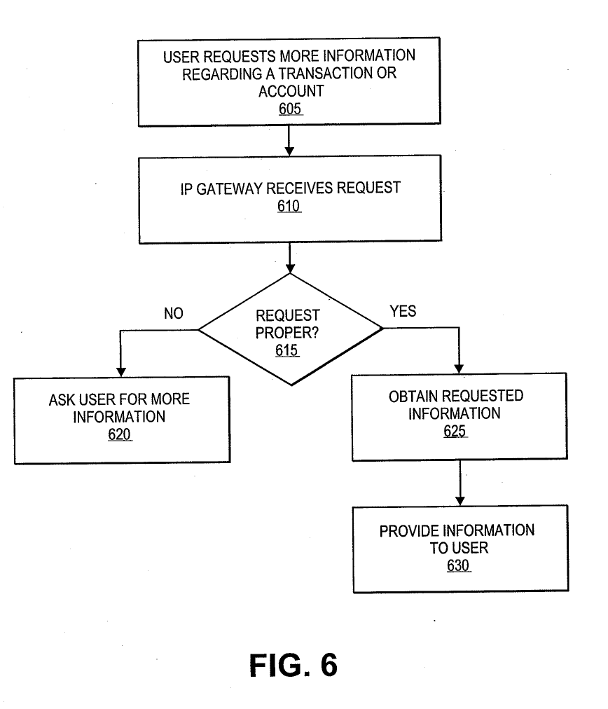

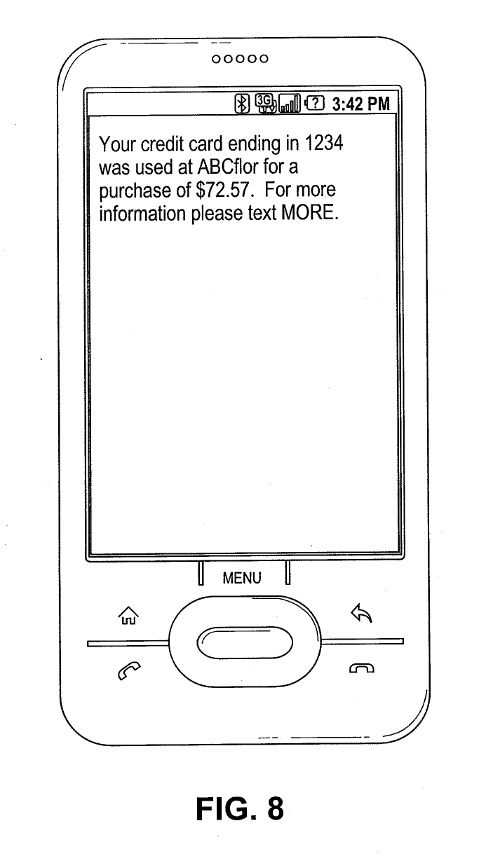

An alert message may communicate required details in a single communication or provide a method for the consumer to request additional information using the same communication channel. For example, a transaction alert received via SMS for an internet purchase and may not include a merchant name due to a message length limitation. FIG. 8 shows an example of an alert that has a truncated merchant name and instructions to text MORE for more information. Referring to FIG. 6, the user 110 may send an SMS message to request the merchant name for this transaction. After typing in the word “MORE” into his mobile device 200, the user 110 would send the alert response message 6c (step 605). The alert response message 6c would be received by the mobile device carriers 190 and the mobile device carriers 190 would send the alert response message 6c to IP Gateway 170.

Once the IP Gateway 170 receives the alert response message (step 610) it would determine whether the request is proper (step 615). For example, a user 110 may mistype the word MORE and instead send a request for MROE. The IP Gateway 170 may send an alert message to the consumer asking for more information (step 620). The alert message may specify that they user 110 may have mistyped the request or may give common command suggestions (e.g., MORE, LAST 3 TRANSACTIONS, SWIPE OR KEYED, TOTAL LAST 30 DAYS, etc.). The request may also, or in the alternative, point the user to a website or other location that contains a list of all commands that can be used in an alert response message. There may be any number of commands available for the user 110 to use.

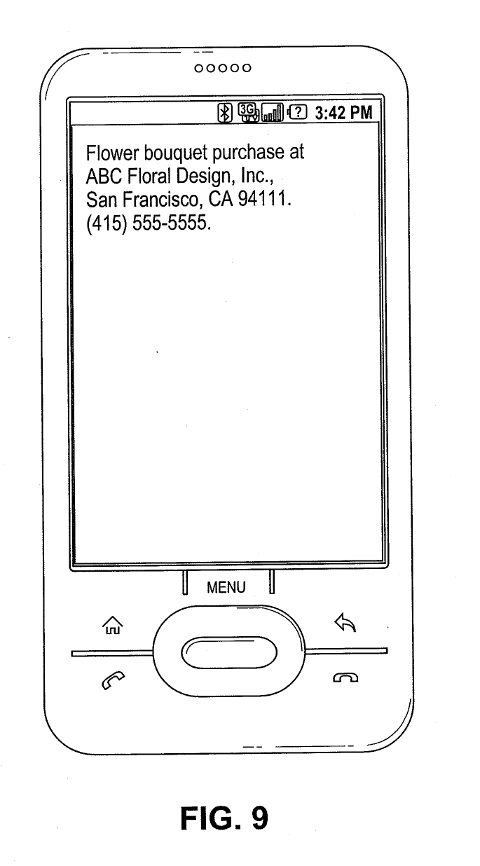

If the request is proper, the IP Gateway 170 obtains the requested information (step 625). The IP Gateway 170 may utilize response data 175 to determine what information is requested. For example, if the user 110 requested “MORE,” the IP Gateway 170 may look up the command “MORE” in the response data to get instructions on the information to provide. The IP Gateway 170 will then generate an alert response message 6c with the requested information and send it to the user 110 via the mobile device carriers 190 (step 630). A consumer may receive an alert as shown in FIG. 9.

As mentioned above, there are many types of commands that may be available for the user 110 to use. Another example is where the user 110 may receive an alert and want to talk to a customer representative about something related to the alert. For example, the alert may be for a transaction he did not make, or may be for the wrong amount, or may remind him about other questions he has related to account the alert refers to. In this case the user 110 may send an SMS message to request to speak to someone. After typing the word “TALK” into his mobile device 200, the user 110 would send the alert response message 6c (step 605). The alert response message 6c would be received by the mobile device carriers 190 and the mobile device carriers 190 would send the alert response message 6c to IP Gateway 170.

Once the IP Gateway 170 receives the alert response message (step 610) it would determine whether the request is proper (step 615). For example, a user 110 may mistype the word TALK and instead send a request for TLK. The IP Gateway 170 may send an alert message to the consumer asking for more information (step 620). The alert message may specify that they user 110 may have mistyped the request or may give common command suggestions (e.g., MORE, LAST 3 TRANSACTIONS, SWIPE OR KEYED, TOTAL LAST 30 DAYS, etc.). For example, common commands may be part of a basic template that appear for all messages. The request may also, or in the alternative, point the user to a website or other location that contains a list of all commands that can be used in an alert response message. There may be any number of commands available for the user 110 to use.

If the request is proper, the IP Gateway 170 obtains the requested information (step 625). The IP Gateway 170 may utilize response data 175 to determine what information is requested. For example, if the user 110 requested “TALK,” the IP Gateway 170 may look up the command “TALK” in the response data to get instructions on the information to provide. In this case the IP Gateway would check the preferences for the user 110 to determine what number they prefer to be contacted with or use the phone number associated with the alert response message 6c. The IP Gateway 170 would then contact the appropriate customer support center and get the user's contact number queued in the system in the call center for them to call the user 110. The IP Gateway 170 will then generate an alert response message 6c to let the user 110 know that they are in the call center queue and send it to the user 110 via the mobile device carriers 190 (step 630). The alert response message 6c may also include the amount of time the user 110 can expect to wait until a consumer representative calls him.

Embodiments of the invention provide a number of advantages. As noted above, a user can quickly and easily change his delivery options for alerts by simply sending an SMS message and can also quickly and easily request more information about a transaction or account by simply sending an SMS message. This way the consumer may avoid excess fees for receiving alerts while traveling or when he is over the limit on his data plan. This is also beneficial to merchants, issuers, and payment processing networks because it does not require that the user call customer support to change his options or to request more information which can be costly to these entities. It also may be simpler to implement a system for responding to alert messages than other systems for updating delivery options. Also, it is more likely that a user will enroll to receive alerts if he knows that it is simple to change delivery options when he wants to stop, pause, or resume alerts (for example). If more users receive alerts there is more opportunity for users to detect potentially fraudulent activity occurring on their account. This also allows merchants, issuers, and payment processing networks to reach more users for account information and offers and promotions related to a user account, purchases, preferences, etc.

Computer System

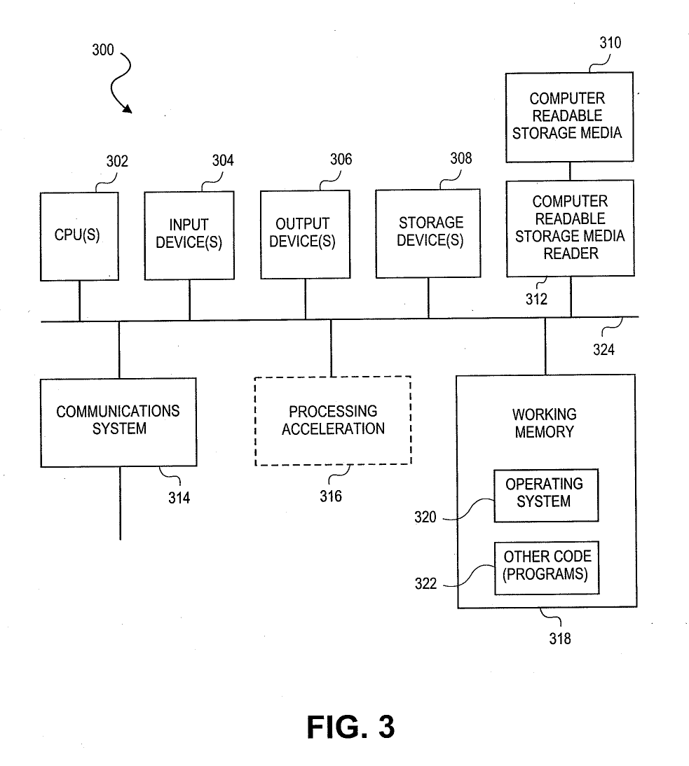

FIG. 3 illustrates an exemplary computer system 300, in which various embodiments may be implemented. The system 300 may be used to implement any of the computer systems described above (e.g., user computer 210, notification server computer 171, payment processing server 186, etc.). The computer system 300 is shown comprising hardware elements that may be electrically coupled via a bus 324. The hardware elements may include one or more central processing units (CPUs) 302, one or more input devices 304 (e.g., a mouse, a keyboard, etc.), and one or more output devices 306 (e.g., a display device, a printer, etc.). The computer system 300 may also include one or more storage devices 308. By way of example, the storage device(s) 308 can include devices such as disk drives, optical storage devices, solid-state storage device such as a random access memory (“RAM”) and/or a read-only memory (“ROM”), which can be programmable, flash-updateable and/or the like.

The computer system 300 may additionally include a computer-readable storage media reader 312, a communications system 314 (e.g., a modem, a network card (wireless or wired), an infra-red communication device, etc.), and working memory 318, which may include RAM and ROM devices as described above. In some embodiments, the computer system 300 may also include a processing acceleration unit 316, which can include a digital signal processor DSP, a special-purpose processor, and/or the like.

The computer-readable storage media reader 312 can further be connected to a computer-readable storage medium 310, together (and, optionally, in combination with storage device(s) 308) comprehensively representing remote, local, fixed, and/or removable storage devices plus storage media for temporarily and/or more permanently containing, storing, transmitting, and retrieving computer-readable information. The communications system 314 may permit data to be exchanged with the network and/or any other computer described above with respect to the system 300.

The computer system 300 may also comprise software elements, shown as being currently located within a working memory 318, including an operating system 320 and/or other code 322, such as an application program (which may be a client application, Web browser, mid-tier application, RDBMS, etc.). It should be appreciated that alternate embodiments of a computer system 300 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A system comprising:
a server comprising a processor and a computer readable medium coupled to the processor, the computer readable medium comprising computer readable program code embodied therein, the computer readable program code adapted to be executed by the processor to receive a request to modify delivery instructions for alerts associated with a consumer, and modify delivery instructions for alerts associated with the consumer;
a database coupled to the server; and
a notification device in operative communication with the server.

2. A method comprising:
receiving, at a server computer, a request to modify delivery instructions for alerts associated with a consumer; and
modifying delivery instructions for alerts associated with the consumer.

3. The method of claim 2 wherein the request includes an identifier associated with a consumer account, and wherein the method further comprises providing confirmation that delivery instructions for alerts associated with the consumer have been modified as requested.

4. The method of claim 3 wherein the delivery instructions are modified only for alerts associated with the consumer account.

5. The method of claim 2 wherein the request includes an amount of time to modify the delivery instructions and wherein the delivery instructions for the alerts are only modified for the amount of time.

6. The method of claims 5 wherein the confirmation includes an indication that alerts will resume after the amount of time passes.

7. The method of claim 2 wherein the confirmation is received at a notification device.

8. The method of claim 7 wherein the notification device is a phone or PDA.

9. The method of claim 2 wherein the request was sent by a consumer using a mobile device.

10. The method of claim 2 wherein the request to modify delivery instructions includes a request to stop, pause, or resume the alerts.

11. The method of claim 10 wherein modifying delivery instructions for alerts includes setting a flag in a database to indicate notifications are paused or resetting the flag in the database to indicate notifications are resumed.

12. A computer readable medium comprising:
computer readable program code embodied therein, the computer readable program code adapted to be executed by a processor to implement the method of claim 2.

13. A server computer comprising the processor; and the computer readable medium of claim 12 coupled to the processor.

14. A method comprising:
receiving, at a server computer, a request for more information related to an alert associated with a payment transaction wherein the alert was received by a consumer at a notification device;
determining if the request is proper;
if the request is proper, obtaining the more information requested; and
sending a response message with the more information.

15. The method of claim 14 wherein if the request is not proper, sending a response message asking the consumer to resend the request.

16. The method of claim 14 wherein the request for more information includes a request for the merchant name for the transaction, a request to talk to a customer support representative, a request for the last three transactions made on the consumer's account, a request for whether the payment card was swiped or keyed during the transaction, and a request for how much the consumer has spent on the account in the last thirty days for a particular merchant.

17. The method of claim 14 wherein the request includes an identifier associated with a consumer account.

18. The method of claim 17 wherein the identifier is used to provide more information related to the consumer account.

19. A computer readable medium comprising:
computer readable program code embodied therein, the computer readable program code adapted to be executed by a processor to implement the method of claim 14.

20. A server computer comprising the processor; and the computer readable medium of claim 19 coupled to the processor.

21. A notification device comprising:
a processor;
an antenna coupled to the processor; and
a computer readable medium coupled to the processor, the computer readable medium comprising code for receiving alerts associated with a consumer account, code for sending a request to modify delivery instructions for the alerts wherein a server computer associated with a payment processing network receives a request to modify delivery instructions for alerts associated with a consumer, modifies delivery instructions for alerts associated with the consumer, and provides confirmation that delivery instructions for alerts associated with the consumer have been modified as requested.
